(19) United States
(12) Patent Application Publication
(10) Pub. No.: US 2024/0086170 A1
(43) Pub. Date: Mar. 14, 2024

(54) SOFTWARE UPDATE SYSTEM AND SOFTWARE UPDATE METHOD

(71) Applicant: RENESAS ELECTRONICS CORPORATION, Tokyo (JP)

(72) Inventor: Hisashi TSUKIASHI, Tokyo (JP)

(21) Appl. No.: 17/941,500

(22) Filed: Sep. 9, 2022

(51) Int. Cl. G06F 8/65; G06F 8/71; G06F 21/57

(52) U.S. Cl. CPC G06F 8/65; G06F 8/71; G06F 21/57

(57) ABSTRACT

If the program stored in the external storage itself is replaced by a legitimate old version of the program by a malicious third party, the semiconductor device (for example, SoC) cannot recognize that it is an old version of the program, and the program can be easily rolled back. An OTP (One Time Programmable ROM) is installed in the chip to manage the latest software version. Specifically, the software version information is checked to see if it is older than the OTP version information by linking the electronic signature updated each time the software is updated with the control table containing the latest software version information stored in the OTP, and comparing the OTP management table with the software version information at system startup.

### BACKGROUND

The present invention relates to a method for safely updating software in a secure semiconductor device.

In recent years, connectivity has been developed in the automotive field, and as the automotive itself is becoming a high-performance computer, the introduction of OTA (Over the Air: a technique for transmitting and receiving data via radio communication) for efficiently updating in-vehicle software is advancing. On the other hand, there is a demand for secure software update methods in on-board systems, such as preventing updates of dangerous/invalid software and verifying software updates.

Traditionally, security technologies such as software encryption and software authenticity verification have been used as software update methods.

FIG. 1 is a diagram for explaining an example of a software update method according to a prior art.

In a server 2 which manages updating of a program, an encrypted update program is generated by encrypting an update target program with a common key (encryption key). At the same time, a hash value (A) is calculated from the update target program by a one-way hash function, and an electronic signature is generated from the calculated hash value (A) by a private key (key pair with the common key). The generated encrypted updated program and electronic signature are transmitted to the semiconductor device (hereinafter, SoC 1).

In the SoC 1 using the update program, the verification process is performed by the received encrypted update program and the electronic signature. The encrypted update program is decrypted using a common key (encryption key) and becomes an update program, and the hash value (B) is calculated from the update program using a one-way hash function. On the other hand, the electronic signature is decrypted by a public key (key pair with the common key) and becomes a hash value (A). The SoC 1 compares the hash value (A) with the hash value (B). The comparison results are sent to the server 2. As a result of the comparison, if matched, the SoC 1 stores the encrypted updating program and the electronic signature in the non-volatile memory 3 as an authentic program.

FIG. 2 is a diagram for explaining an example of a start method of the software according to the prior art.

When starting the update software, the SoC 1 reads the encrypted update program and the electronic signature from the non-volatile memory 3 and verifies the update program. The encrypted update program is decrypted using a common key (encryption key) and becomes an update program, and the hash value (B) is calculated from the update program using a one-way hash function. On the other hand, the electronic signature is decrypted by a public key (key pair with the common key) and becomes a hash value (A). As a result of comparing the hash value (A) and the hash value (B), if they match, the update program can be executed as a regular program.

### SUMMARY

However, if the program itself stored in the external storage is replaced by a legitimate old version of the program by a malicious third party, a semiconductor device (for example, SoC) cannot recognize that it is an old version of the program, and the program can be easily rolled back. In other words, an older version of a program is regarded as legitimate software and runs. If the previous version of the program is severely vulnerable, it will directly lead to the vulnerability of the on-board system, which may lead to serious situations such as accidents caused by malfunctions.

According to an embodiment, an OTP (One Time Programmable ROM) is provided in the semiconductor device to manage the latest software version information. Specifically, the software version information is checked to see if it is older than the OTP version information by linking the electronic signature updated each time the software is updated with the control table containing the latest software version information stored in the OTP, and comparing the OTP management table with the software version information at system startup.

According to the embodiment, the rollback can be detected even if the software stored in the external storage itself is replaced with the legitimate old software, and the latest version of the software that is always safe can be started.

### BRIEF DESCRIPTION OF THE DRAWINGS

FIG. 1 is a diagram for explaining an example of a software update method according to a prior art.

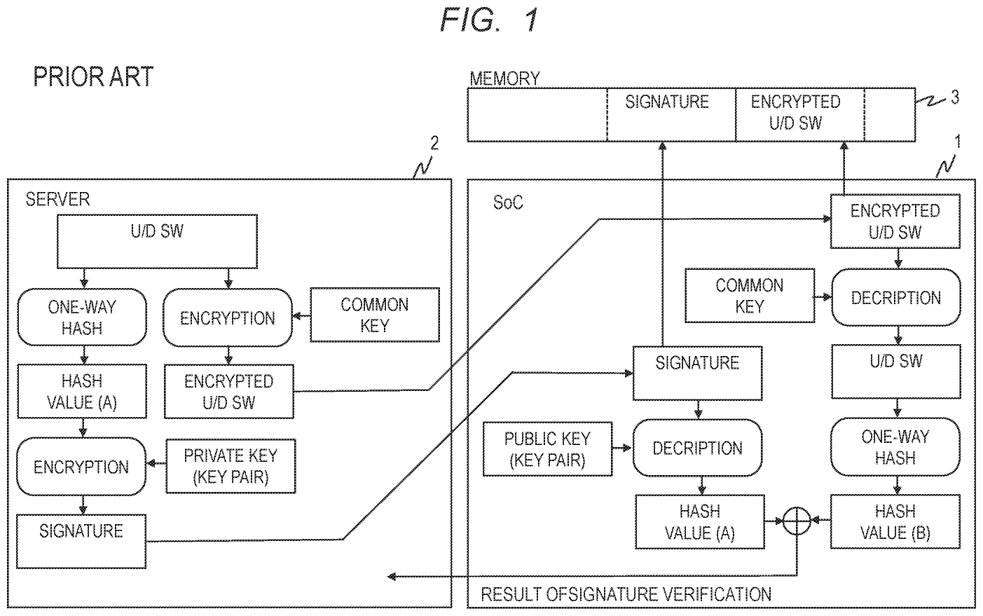

FIG. 2 is a diagram for explaining an example of a start method of the software according to the prior art.

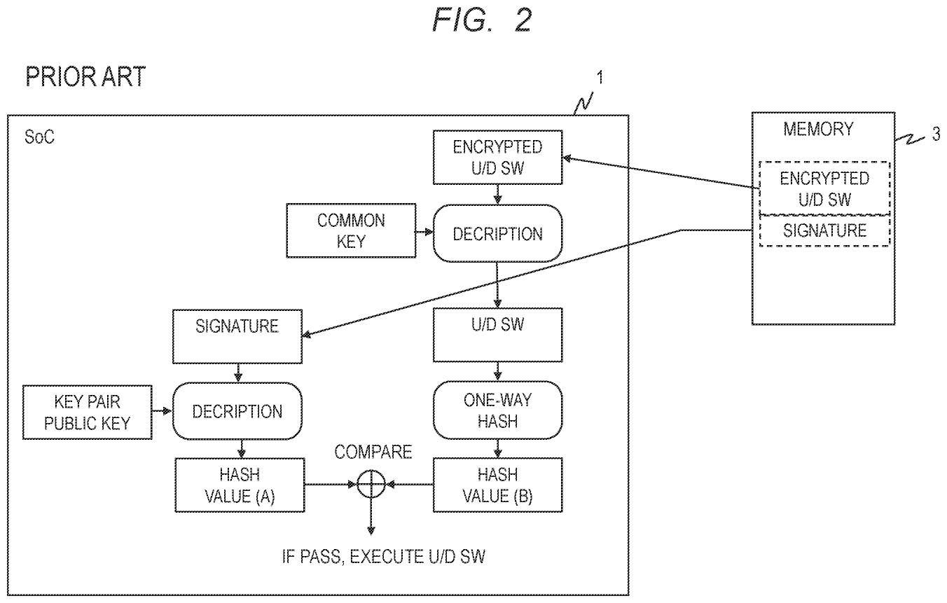

FIG. 3 is a configuration diagram of a software update system according to a first embodiment.

FIG. 4 is a software update flow diagram according to the first embodiment.

FIG. 5 is a diagram for explaining a software update flow according to the first embodiment.

FIG. 6 is a configuration diagram of a software update system according to the first embodiment (at the time of system startup).

FIG. 7 is a system start flow diagram according to the first embodiment.

FIG. 8 is a diagram for explaining a system start flow diagram according to the first embodiment.

FIG. 9 is a configuration diagram of a software update system according to a second embodiment.

FIG. 10 is a software update flow diagram according to the second embodiment.

FIG. 11 is a diagram for explaining a software update flow according to the second embodiment.

FIG. 12 is a configuration diagram of a software update system according to the second embodiment (at the time of system startup).

FIG. 13 is a system start flow diagram according to the second embodiment.

FIG. 14 is a diagram for explaining a system startup flow according to the second embodiment.

FIG. 15 is a diagram for explaining a plurality of software centralized management according to a modified example.

FIG. 16 is a configuration diagram of a software centralized management system according to the modified example.

FIG. 17 is a diagram for explaining data stored in a secure storage unit in a software centralized management system according to the modified example.

FIG. 18 is a software centralized management flow diagram at the software download according to the modified example.

FIG. 19 is a diagram for explaining a software centralized management flow according to the modified example.

FIG. 20 is a software centralized management flow diagram at the system startup according to the modified example.

### DETAILED DESCRIPTION

Hereinafter, a software update system according to an embodiment will be described in detail by referring to the drawings. In the specification and the drawings, the same or corresponding form elements are denoted by the same reference numerals, and a repetitive description thereof is omitted. In the drawings, for convenience of description, the configuration may be omitted or simplified. Also, at least some of the embodiments may be arbitrarily combined with each other.

### First Embodiment

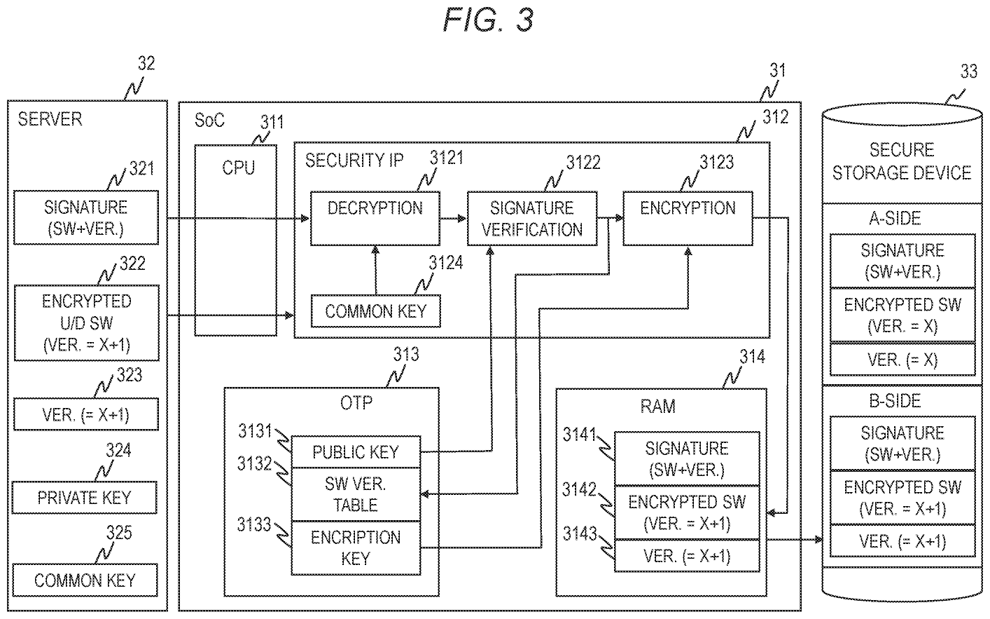

FIG. 3 is a software update system configuration diagram according to the first embodiment. The software update system includes a semiconductor device (hereinafter, SoC) 31, a server 32, and a secure storage unit 33. The SoC 31 includes a CPU 311, a secure IP 312, an OTP unit 313, and a RAM 314. The secure IP 312 includes a decryption unit 3121, a signature verification unit 3122, and an encryption unit 3123. The server 32 stores the electronic signature 321, software (X+1 version) 322, and software version information (=X+1) 323. The electronic signature 321 includes the electronic signature 321 generated from software (X+1 version) 322 and software version information (=X+1) 323 at least. The OTP unit 313 stores a public key 3131, a software version management table 3132, and an encryption key 3133. The secure storage unit 33 stores electronic signatures, software (X version), and software version information (=X). The SoC 31 and the server 32 also have common keys (3124, 325) for encrypting and decrypting the software. The electronic signature 321 may be configured to be managed together with other information as a secure boot certificate.

### (Software Update)

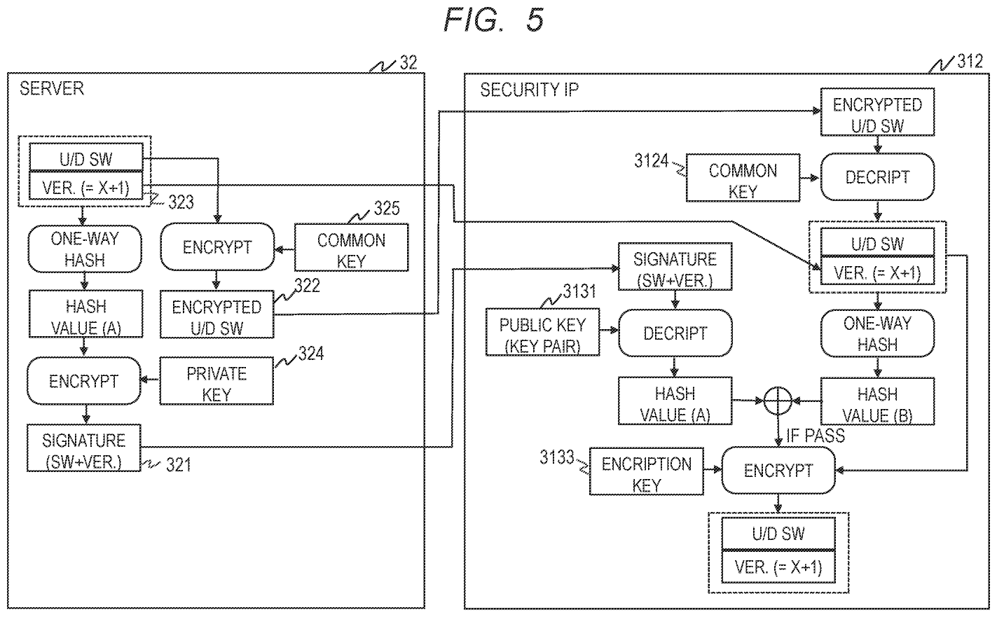

The process of updating the software from X version to X+1 version will be described in accordance with FIGS. 3 to 5. The server 32 executes the process illustrated in FIG. 5 in advance for software update, creates an encrypted electronic signature (SW+version information) 321 and an encrypted update software 322. More specifically, the update software (X+1 version) is encrypted with the common key 325 to create the encrypted update software 322. Similarly, the hash value (A) is calculated from the update software (X+1 version) and the version information (=X+1) by the one-way hash function, and the encrypted hash value (A) is created by encrypting with the private key 324.

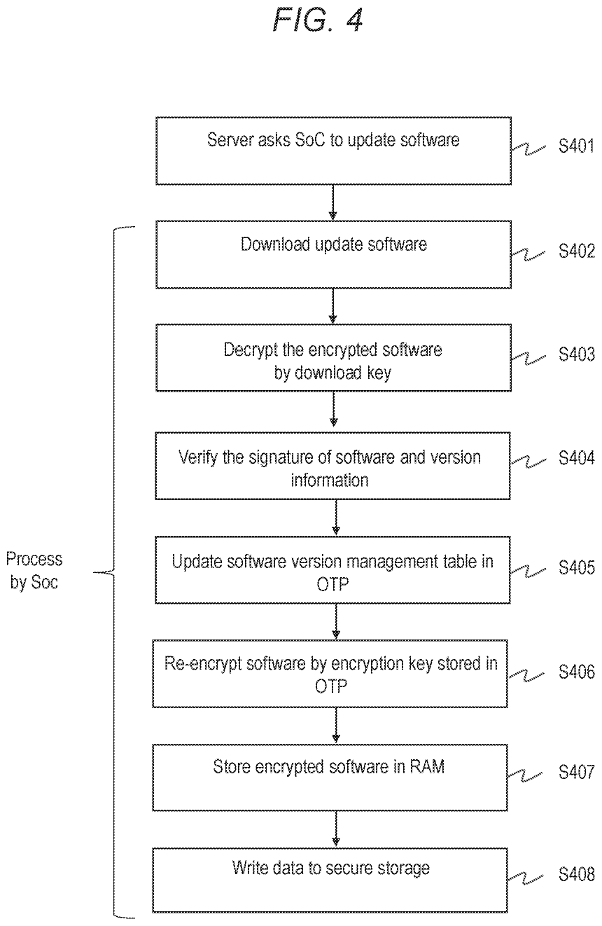

The flow of software update will be described with reference to FIG. 4. First of all, the server 32 requires the SoC 31 to update the software (step S401). Upon receipt of the update request, the SoC 31 downloads the encrypted update software 322 from the server 32 over the CPU 311 (step S402). The security IP 312 decrypts the downloaded encrypted update software 322 with the common key 3124 and generates the update software (step S403). Next, the security IP 312 performs the signature verification process (step S404).

The signature verification process will be described in more detail with reference to FIG. 5. The encrypted hash value (A) 321 is decrypted by the public key 3131 stored in the OTP unit 313 and becomes the hash value (A). On the other hand, the hash value (B) is calculated by the one-way hash function from the update software and the version information decrypted by the step S403. The hash value (A) and the hash value (B) are compared, and if they match, it is determined that the software is a regular update. If there is a mismatch, it is determined that an illegal software update is performed, and process such as notifying the determination result to the software update source is performed.

When it is determined that the software is regular update in the signature verification process (step S404), the software version management table 3132 stored in the OTP unit 313 is updated (step S405). The update of the software version management table 3132 may be, for example, a method of appending “1” to the table (“00000001” before updating, “00000011” after updating) or other methods.

Next, the updating software is re-encrypted with the encryption key 3133 stored in the OTP unit 313 (step S406). The electronic signature, the encrypted updated software, and the version information are stored in the RAM 314 (step S407). Further, the content stored in the RAM 314 is written to the secure storage unit 33 (step S408).

### (System Startup Using Update Software)

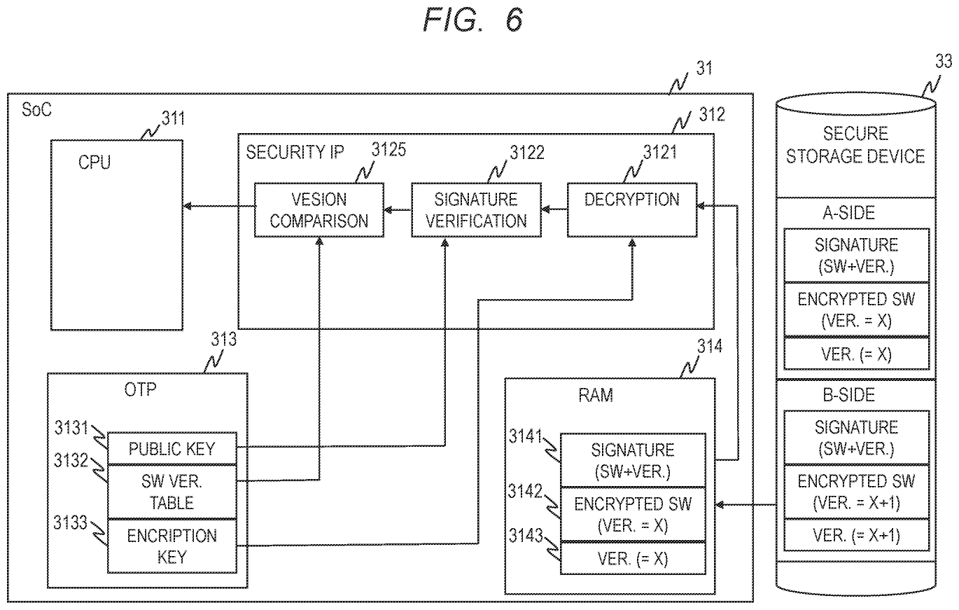

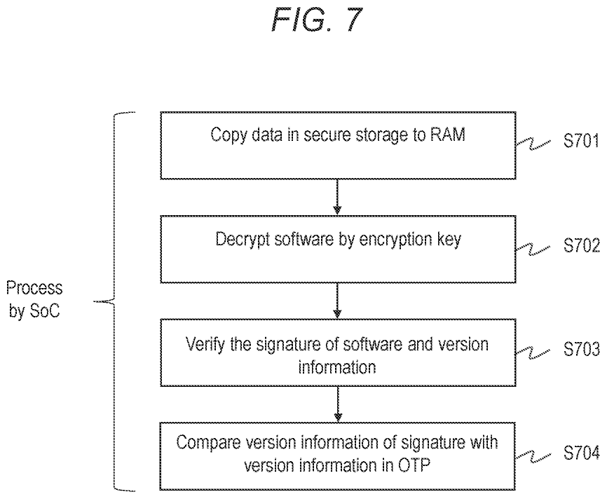

The process at the time of system startup will be described with reference to FIGS. 6 to 8.

First, the SoC 31 loads the electronic signature 3141, the encrypted update software 3142 and the version information 3143 stored in the secure storage 33 into the RAM 314 (step S701). The encrypted update software 3142 is decrypted with the encryption key 3133 stored in the OTP unit 313 (step S702). Next, the security IP 312 performs signature verification process of SW+version information (step S703).

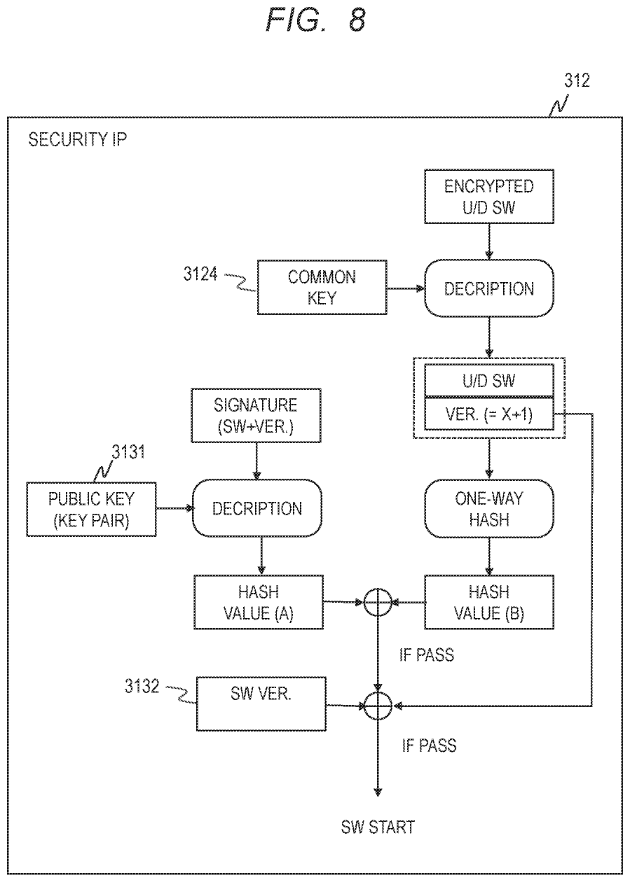

The signature verification process will be described in more detail with reference to FIG. 8. The encrypted hash value 3141 is decrypted by the public key 3131 stored in the OTP unit 313 and becomes a hash value (A). On the other hand, the hash value (B) is calculated by the one-way hash function from the update software and the software version information decrypted by the step S702. The hash value (A) and the hash value (B) are compared, and if they match, then the software version information stored in the OTP unit 313 is compared with the software version information stored in the RAM 314 (step S704). As a result of the comparison, if they match, the verification process completed and the update software will start. If there is a mismatch, the software is judged to be an illegal software update, and process such as stopping the system startup is performed.

Note that updating of the software version management table 3132 in the OTP unit 313 may be written after signature verification by recognizing that the system is started or the software has been updated. In such case, the comparative of version information shall be made at the subsequent system startup. In addition, the comparison of version information at system startup may be before decryption or before signature verification.

According to the first embodiment, the rollback can be detected even if the external storage itself is replaced with legitimate old software, and the latest version of the software that is always safe can be started.

### Second Embodiment

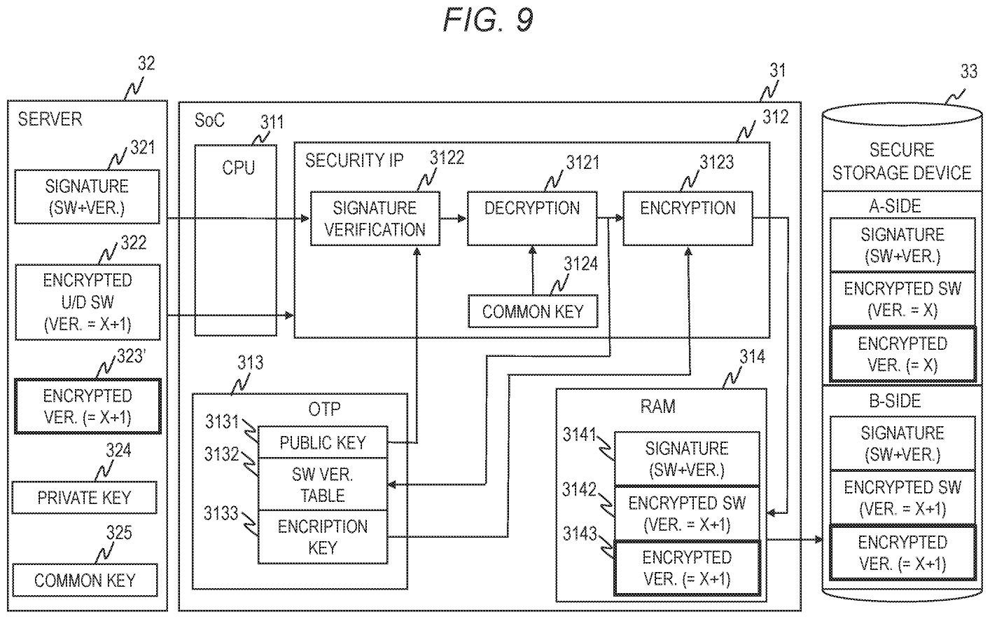

In the first embodiment, a configuration in which the update software is encrypted and the version information of the software is not encrypted has been described, but in a second embodiment, a software update method in which the version information of the software is also encrypted will be described. FIG. 9 is a software update system configuration diagram according to the second embodiment. The software update system configuration diagram (FIG. 3) according to the first embodiment differs from the process flow in the security IP 312 in that the software version information 323′ is encrypted.

### (Software Update)

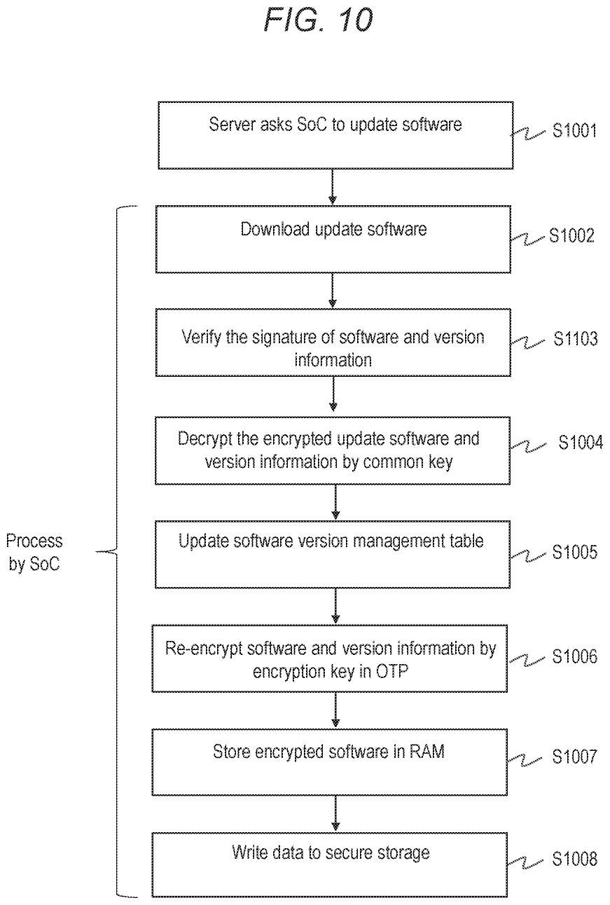

The process of updating the software from X version to X+1 version will be described in accordance with FIGS. 9 to 11.

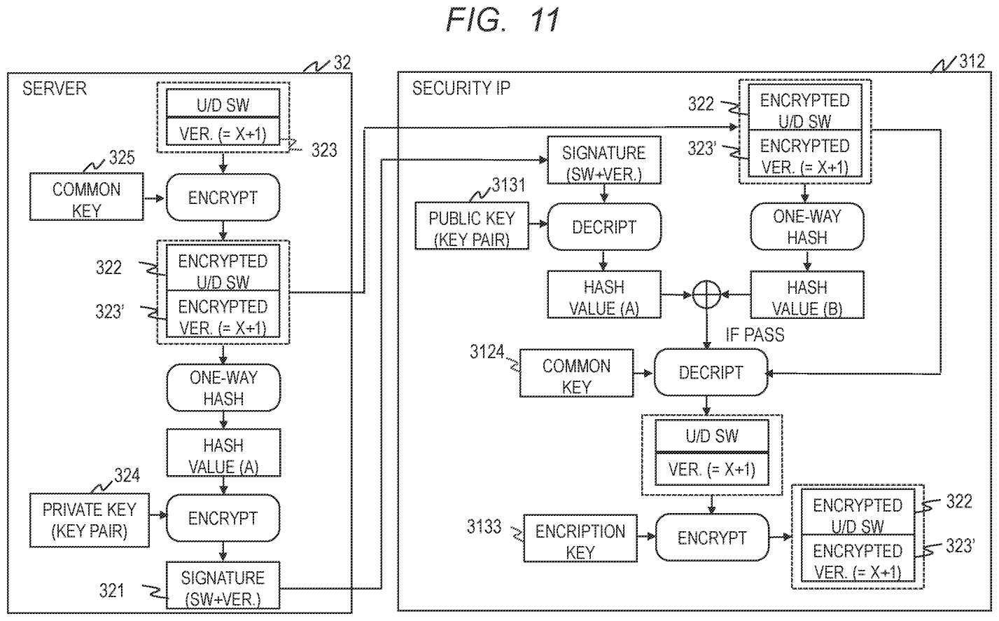

In advance, the server 32 executes the process for software update illustrated in FIG. 11, and creates an encrypted electronic signature (SW+version information) 321, an encrypted update software 322, and encrypted version information 323′. More specifically, the update software (X+1 version) and version information are encrypted with the common key 325 to create encrypted update software 322 and encrypted version information 323′. Further, the hash value (A) is calculated from the encrypted update software (X+1 version) 322 and the encrypted version information (=X+1) 323′ using a one-way hash function, and the encrypted hash value (A) is created by encrypting with the private key 324.

To update the software, the server 32 requests the SoC 31 to update the software (step S1001). Upon receipt of the update request, the SoC 31 downloads the encrypted update software 322 and the encrypted version information 323′ from the server 32 over the CPU 311 (step S1002). Next, the security IP 312 performs the signature verification process (step S1003).

The signature verification process will be described with reference to FIG. 11. The encrypted hash value (A) 321 is decrypted by the public key 3131 stored in the OTP unit 313 and becomes the hash value (A). On the other hand, the hash value (B) is calculated from the encrypted update software and the encrypted version information using a one-way hash function. The hash value (A) and the hash value (B) are compared, and if they match, it is determined that the software is a regular update. If there is a mismatch, it is determined that an illegal software update is performed, and process such as notifying the determination result to the software update source is performed. If it is determined that the signature verification process (step S1003) is a regular software update, the encrypted update software and the encrypted version information are decrypted with the common key 3124 (step S1004). The software version management table 3132 stored in the OTP unit 313 is updated (step S1005). The update of the software version management table 3132 may be, for example, a method of appending “1” to the table (“00000001” before updating, “00000011” after updating) or other methods.

Next, the security IP 312 re-encrypts the update software with the encryption key 3133 stored in the OTP unit 313 (step S1006) and stores the electronic signature, encrypted updating software, and encrypted version information in RAM 314 (step S1007). Further, the content stored in RAM 314 is written to the secure storage unit 33 (step S1008).

### (System Startup Using Update Software)

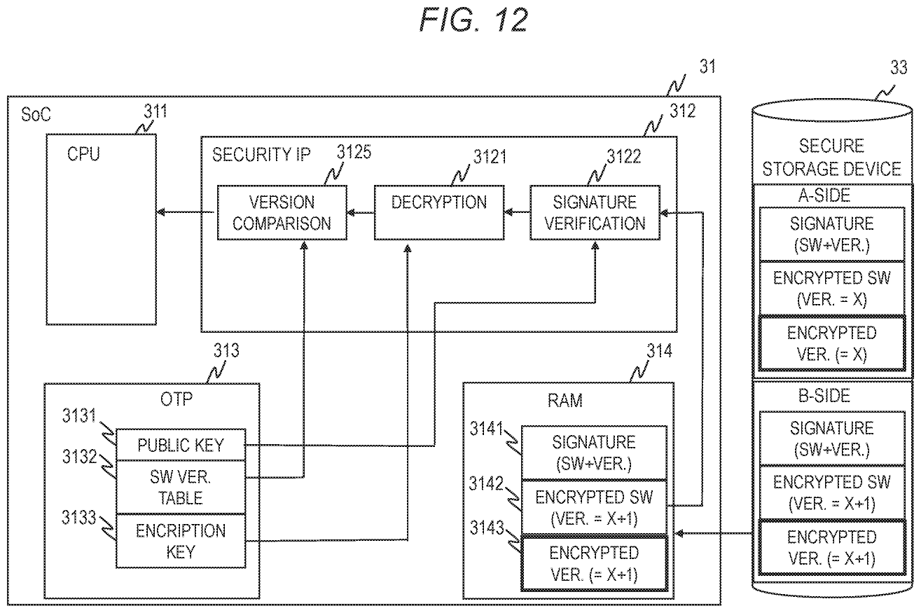

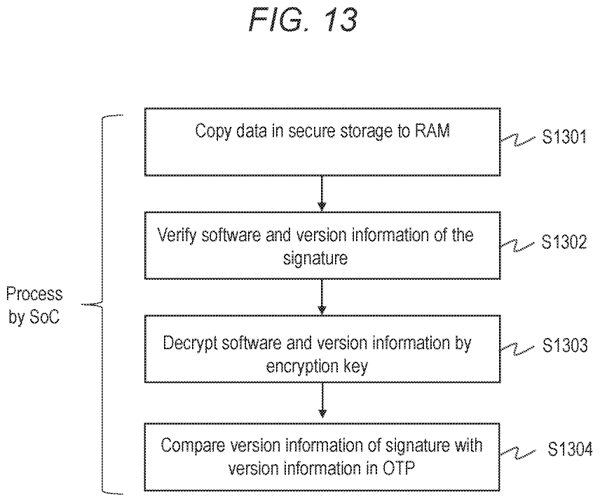

The process at the time of system startup will be described with reference to FIGS. 12 to 14.

At first, the SoC 31 loads the electronic signature, encrypted update software 3142 and encrypted software version information 3143 stored in the secure storage 33 into RAM 314 (step S1301). Next, the security IP 312 performs the signature verification process of the SW+version data (step 31302).

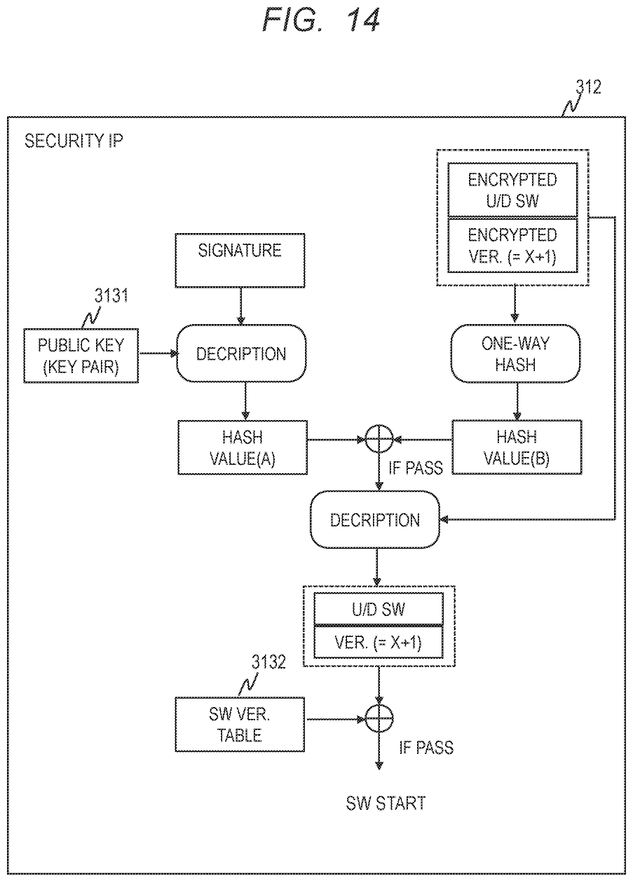

The signature verification process will be described in detail with reference to FIG. 14. The encrypted hash value 3141 is decrypted by the public key 3131 stored in the OTP unit 313 and becomes a hash value (A). On the other hand, the hash value (B) is calculated from the encrypted update software and the encrypted software version information using a one-way hash function. The hash value (A) and the hash value (B) are compared, and if they match, it is determined that the software is a regular update. If there is a mismatch, the software is determined to be an illegal software update, and process such as stopping system startup is performed.

If it is determined that the signature verification process (step S1302) is a regular software update, the encrypted update software and the encrypted version information are decrypted with the common key 3124 (step S1303). Next, the software version information is compared (step S1304) with the software version management table 3132 stored in the OTP unit 313. As a result of the comparison, if they match, the verification process completed and the update software will start. If there is a mismatch, the software is determined to be an illegal software update, and process such as stopping system startup is performed. The update of the software version management table 3132 of the OTP unit 313 may be written at the time of system activation or after signature verification upon recognizing that the software has been updated. In this case, the version comparison is performed at subsequent system startup.

According to the second embodiment, the rollback can be detected even if the external storage itself is replaced with the legitimate old software, and the latest version of the software that is always safe can be started.

### Modified Example

In the first embodiment, a method of updating software in which the update software is encrypted and the version information of the software is not encrypted, and in the second embodiment, a method of updating software in which the version information of the software is also encrypted has been described, but as a modification, a method of centrally managing a plurality of software versions will be described. Specifically, the validity of the software version is verified by comparing the certificates of the integrated software version information that centrally manages multiple software versions with the certificates of the software version information that is also sailed to the individual software.

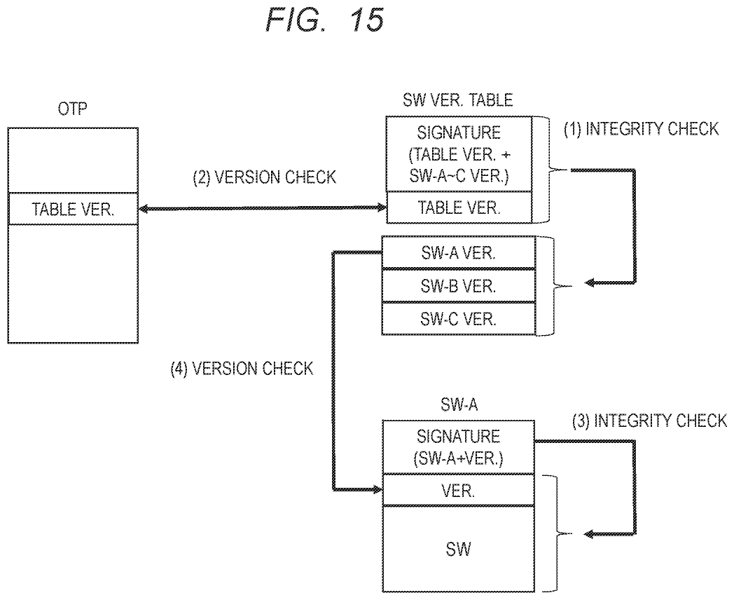

FIG. 15 is a diagram for explaining the concept of centralized management of the software version according to a modification. The software version control table consists of the version of each software (SW-A VER. to SW-C VER.), the version of the table itself (TABLE VER.), and the electronic signature for checking the integrity of TABLE VER and SW-A VER. to SW-C VER.

As illustrated in FIG. 15, verification of the software version takes place in four steps. (1) Verify the signing of the version of the table itself (TABLE VER.) and the integrity of the version (SW-A VER. to SW-C VER.) of the software. (2) In order to check whether the version (TABLE VER.) of the table itself is up to date (that is, whether it is rolled back), it is compared with the version (TABLE VER.) of the table itself stored in the OTP unit. As a result of comparison, if there is no problem in the table, the integrity verification and version check of each software are carried out in (3) and (4).

### (Software Download)

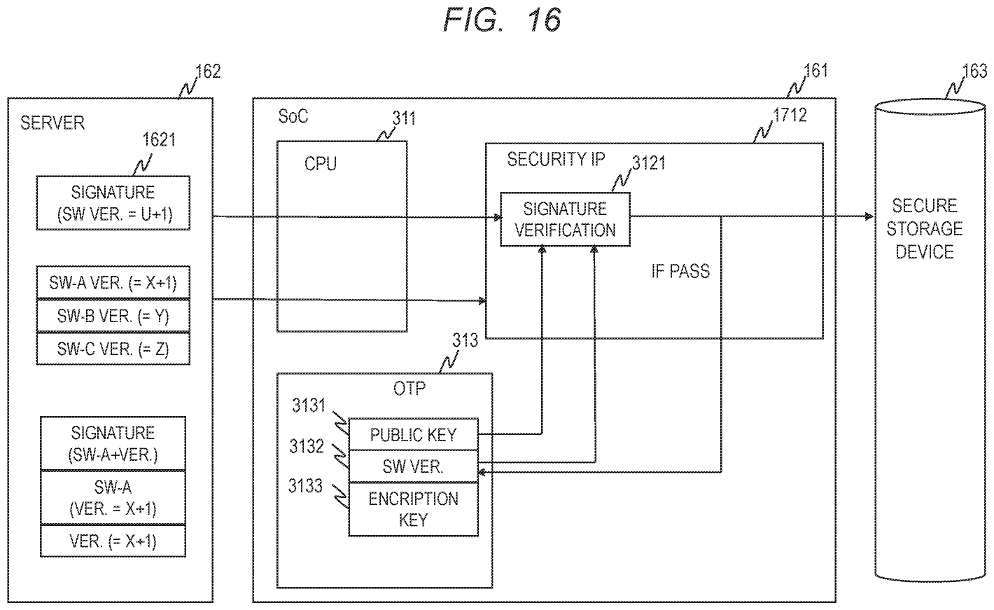

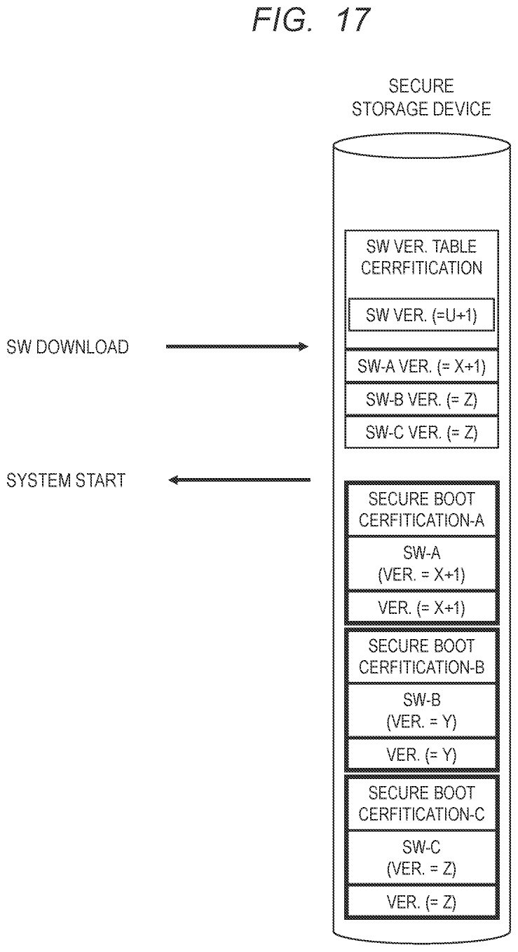

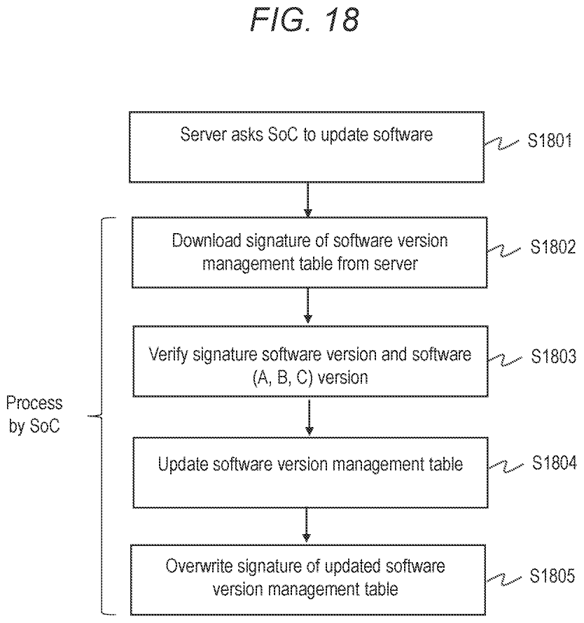

The process of updating the software A from X version to X+1 version will be described in accordance with FIGS. 16 to 18. The software version of the software version control table shall be updated from U version to U+1 by the version update of software A.

To update the software, the server 32 first requests SoC3 1 to update the software (step S1801). When the SoC 31 receives the update request, it downloads the software version control table certificate from the server 32 through CPU 311 (step S1802). The security IP 312 performs signature verification process according to the downloaded software version control table (step S1803). When it is determined that the software is regular update in the signature verification process (step S1803), the software version management table 3132 stored in the OTP unit 313 is updated (step S1804). The update of the software version management table 3132 may be, for example, a method of appending “1” to the table (“00000001” before updating, “00000011” after updating) or other methods.

As a result of the signature verification process, when it is determined that it is a regular software update, verification of whether the software is a regular software update for the software to be updated (software A in FIG. 16) or not is performed by the method of either the first or second embodiment.

### (System Startup Using Update Software)

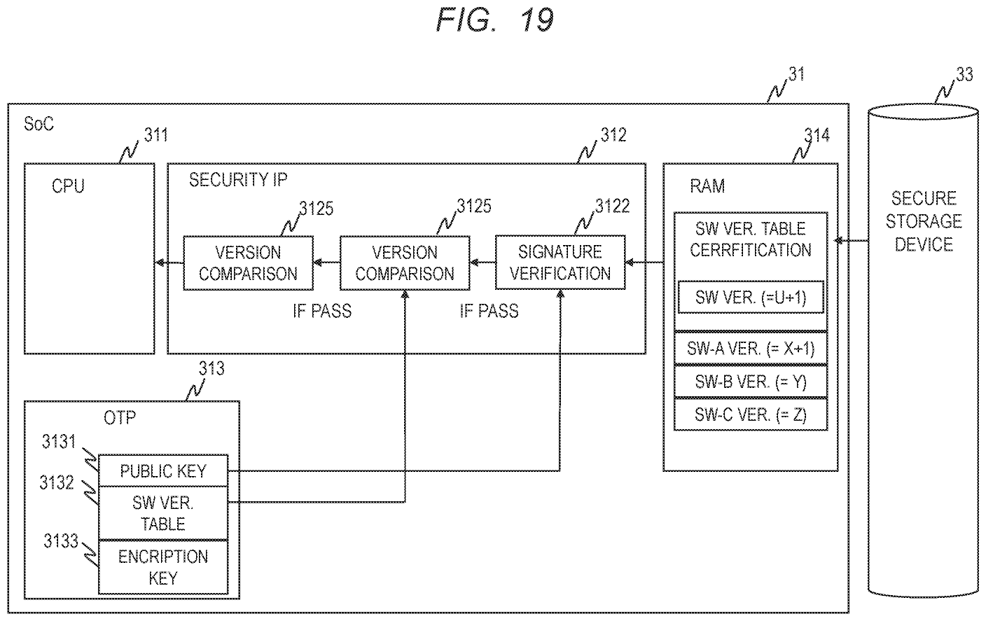

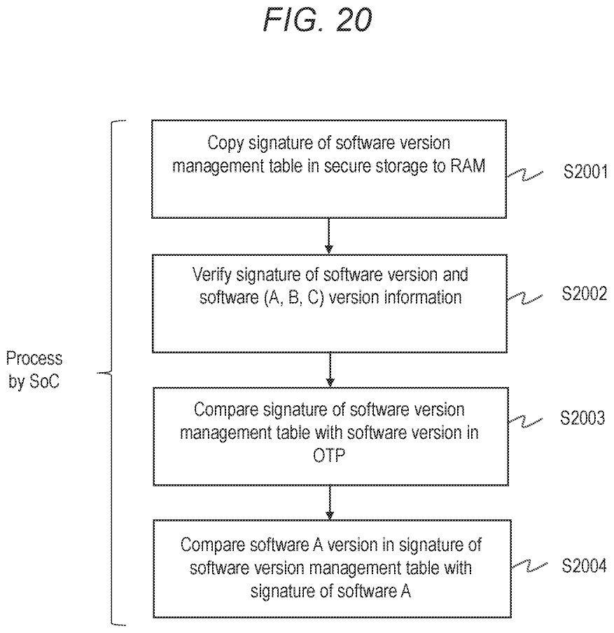

The process at the time of system startup will be described with reference to FIGS. 19 and 20.

First of all, the SoC 31 reads the software version control table certificate stored in the secure storage unit 33 and expands into the read RAM 314 (step S2001). Next, the security IP 312 performs signature verification process based on the software version and the version information of each software (step S2002). The software version of the software version control table certificate is compared with the software bar place m stored in the OTP unit 313 (step S2003). The software A version of the software version control table certificate is compared with the version of the secure boot certificate A (step S2004). As a result of the comparison, if they match, the verification process completed and the update software will start. If there is a mismatch, it is determined that an illegal software update is performed, and process such as notifying the determination result to the software update source is performed.

As a result of the signature verification process, when it is determined that it is a regular software update, verification of whether the software is a regular software update for the software to be updated (software A in FIG. 19) or not is performed by the method of either the first or second embodiment.

Although the invention made by the present inventor has been specifically described based on the embodiment, the present invention is not limited to the embodiment described above, and it is needless to say that various modifications can be made without departing from the gist thereof.

What is claimed is:

1. A software update system comprising a semiconductor device that manages software updates and a server that stores software and a version of the software,
wherein the semiconductor device has a first memory for storing a version table of software,
when updating the software, the server encrypts the update software to generate the encrypted update software, generates a first signature from the update software and the version of the update software, and transmits the encrypted update software, the version of the update software and the first signature to the semiconductor device,
wherein the semiconductor device decrypts the update software to generate the update software and generates a second signature from the version of the update software and the update software, and verifies software rollback by comparing the first signature and the second signature.

2. The software update system according to claim 1, wherein the semiconductor device has a second memory,
when the first signature and the second signature matches, the semiconductor device updates the version table, and stores the update software, a version of the update software and the first signature in the second memory.

3. The software update system according to claim 2,
at system startup, the semiconductor generates a third signature from the version of the update software and the update software stored in the second memory, and compares the first signature stored in the second memory with the third signature,
when the first signature and the third signature are matched, the semiconductor device further verifies software rollback by comparing a version of the update software with a version table of the software stored in the first memory.

4. The software update system according to claim 1,
wherein the version table is a count value and counts up by one each time a software version is updated.

5. The software update system according to claim 1,
wherein the first memory is an OTP (One Time Programmable).

6. The software update system according to claim 1,
wherein a signature is created from the update software and the version of the update software by a one-way hash function.

7. The software update system according to claim 1,
wherein the version of the update software is encrypted.

8. A software update system comprising a semiconductor that manages software updates, and a server that has an update management table plurality of software and versions of the plurality of software,
wherein the semiconductor has a first memory for storing a version table of software,
when updating the software, the server generates a fourth signature from the version of the update management table and the version of the plurality of software, and transmits the version of the update management table, the plurality of software versions and the fourth signature to the semiconductor device, the semiconductor device generates a fifth signature from the version of the update management table and the versions of the plurality of software, and verifies software rollback by comparing the fourth signature with said fifth signature, and updates the version table when the fourth signature and the fifth signature are matched.

9. A software update method in a software update system including a semiconductor for managing software updates and a server for storing software and a version of the software,
the semiconductor device has a first memory for storing a version table of software and a predetermined encryption key,
when updating the software, the server encrypts the update software to generate the encrypted update software, generates a first signature from the update software and the version of the update software, and transmits the encrypted update software, the version of the update software, and the first signature to the semiconductor device,
wherein the semiconductor device decrypts the encrypted update software to generate the update software and generates a second signature from the version of the update software and the update software, and verifies software rollback by comparing the first signature with the second signature.

10. The software update method according to claim 9,
wherein the semiconductor device further has a second memory,
when the first signature and the second signature are matched, and updates the version table,
wherein the update software and the version of the update software and the first signature are stored in the second memory.

11. The software update method according to claim 10,
at system startup, the semiconductor device generate a third signature from the version of the update software and the update software stored in the second memory and compares the first signature stored in the second memory with the third signature,
wherein when the first signature and the third signature are matched, verifies software rollback by comparing a version of the update software with a version table of the software stored in the first memory.

12. A software update method having a semiconductor device that manages software updates, and a server that stores an update management table and a plurality of software and versions of the plurality of software,
wherein the semiconductor device has a first memory for storing a version table of software,
when updating the software, the server generates a fourth signature from the version of the plurality of software and the version of the update management table, and transmits the version of the update management table and the plurality of software versions and the fourth signature to the semiconductor device, the semiconductor device generates a fifth signature from the version of the update management table and the versions of the plurality of software, and verifies the rollback of software by comparing the fourth signature and the fifth signature, and updates the version table when the fourth signature and the fifth signature are matched.
